(19) United States
(12) Patent Application Publication
(10) Pub. No.: US 2022/0172081 A1
(43) Pub. Date: Jun. 2, 2022

(54) TECHNIQUES FOR CONDUCTING EXPLORATION AND EXPLOITATION STRATEGY OF AN INPUT/OUTPUT DEVICE

(71) Applicant: Intuition Robotics, Ltd, Ramat-Gan (IL)

(72) Inventors: Shay ZWEIG, Harel (IL); Alex KEAGEL, Tel Aviv (IL); Itai MENDELSOHN, Tel Aviv (IL); Roy AMIR, Mikhmoret (IL); Eldar RON, Tel Aviv (IL)

(73) Assignee: Intuition Robotics, Ltd, Ramat-Gan (IL)

(21) Appl. No.: 17/538,737

(22) Filed: Nov. 30, 2021

Related U.S. Application Data
(60) Provisional application No. 63/119,255, filed on Nov. 30, 2020.

(51) Int. Cl. G06N 5/04; G06N 3/00

(52) U.S. Cl. CPC G06N 5/04; G06N 3/006

(57) ABSTRACT

A system and method for conducting a strategy of a digital assistant includes identifying a plurality of potential plans for a user based on input data, wherein the plurality of potential plans includes an optimal plan and at least one suboptimal plan, wherein the input data includes historical data and a current state of the user; extracting a first dataset, a second dataset, and a third dataset from the input data, wherein the first dataset provides a rejection history, wherein the second dataset indicates receptiveness level of the user, wherein the third dataset includes confidence levels of expected reward values; determining an exploration score based on the first dataset, the second dataset, the third dataset, and the input data; determining a strategy based on the determined exploration score; and causing the digital assistant to perform at least one of the plurality of potential plans based on the determined strategy.

### CROSS-REFERENCES TO RELATED APPLICATIONS

This application claims benefit of U.S. Provisional Application No. 63/119,255, filed on Nov. 30, 2020, the contents of which are hereby incorporated by reference.

### TECHNICAL FIELD

The disclosure generally relates to digital assistants operated in an input/output (I/O) device, and more specifically to techniques for conducting exploration and exploitation strategy.

### BACKGROUND

As manufacturers improve the functionality of devices such as vehicles, computers, mobile phones, appliances, and the like, through the addition of digital features, manufacturers and end-users may desire enhanced device functionalities. The manufacturers, as well as the relevant end-users, may desire digital features which improve user experiences, interactions, and features which provide for greater connectivity. Certain manufacturers may include device-specific features, such as setup wizards and virtual assistants, to improve device utility and functionality. Further, certain software packages may be added to devices, either at the point of manufacture, or by a user after purchase, to improve device functionality. Such software packages may provide functionalities including, as examples, a computer system's voice control, facial recognition, biometric authentication, and the like.

While the features and functionalities described hereinabove provide for certain enhancements to a user's experience when interacting with a device, the same features and functionalities, as may be added to a device by a user or manufacturer, fail to include certain aspects which may allow for a further-enhanced user experience. In this regard, certain currently-implemented digital assistants use reinforcement learning techniques by which a digital assistant is configured to learn actions, and more specifically map different states to actions in order to maximize a numerical reward signal. Unlike supervised learning models, the digital assistant that use reinforcement learning are not provided with correct set of actions, but instead configured to discover actions that yield the highest reward through trial and error.

Typical reinforcement learning techniques provide multiple actions and plans that can be executed by a digital assistant using exploration and exploitation strategies. Exploration strategy allows the digital assistant to improve its knowledge about each action, which may lead to long-term benefit. Exploitation strategy on the other hand, chooses the greedy action to get the most reward by exploiting the agent's current action-value estimates. Epsilon-Greedy is an example method that is commonly used in robots and other electronic devices that randomly chooses between exploration and exploitation. Deterministic reinforcement learning is another approach that allows selection between exploration and exploitation based on a state of the device, such as a digital assistant. Nevertheless, approaches and solutions in the prior arts disregard real-time circumstances and other external constraints related to the user or the environment from which the digital assistant interacts or provides function to.

Therefore, it would be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for conducting a strategy of a digital assistant. The method comprises: identifying a plurality of potential plans for a user based on input data, wherein the plurality of potential plans includes an optimal plan having a highest expected reward value and at least one suboptimal plan having an expected reward value less than the highest expected reward value, wherein the input data includes historical data and a current state of the user; extracting a first dataset, a second dataset, and a third dataset from the input data, wherein the first dataset provides a rejection history for the plurality of potential plans, wherein the second dataset indicates receptiveness level of the user, wherein the third dataset includes confidence levels of expected reward values for each of the plurality of potential plans; determining an exploration score based on the first dataset, the second dataset, the third dataset, and the input data; determining a strategy based on the determined exploration score; and causing the digital assistant to perform at least one of the plurality of potential plans based on the determined strategy.

Certain embodiments disclosed herein also include a non-transitory computer readable medium having stored thereon causing a processing circuitry to execute a process, the process comprising: identifying a plurality of potential plans for a user based on input data, wherein the plurality of potential plans includes an optimal plan having a highest expected reward value and at least one suboptimal plan having an expected reward value less than the highest expected reward value, wherein the input data includes historical data and a current state of the user; extracting a first dataset, a second dataset, and a third dataset from the input data, wherein the first dataset provides a rejection history for the plurality of potential plans, wherein the second dataset indicates receptiveness level of the user, wherein the third dataset includes confidence levels of expected reward values for each of the plurality of potential plans; determining an exploration score based on the first dataset, the second dataset, the third dataset, and the input data; determining a strategy based on the determined exploration score; and causing the digital assistant to perform at least one of the plurality of potential plans based on the determined strategy.

Certain embodiments disclosed herein include a system for conducting a strategy of a digital assistant. The system comprises: a processing circuitry; and a memory, the memory containing instructions that, when executed by the processing circuitry, configure the system to: identify a plurality of potential plans for a user based on input data, wherein the plurality of potential plans includes an optimal plan having a highest expected reward value and at least one suboptimal plan having an expected reward value less than the highest expected reward value, wherein the input data includes historical data and a current state of the user; extract a first dataset, a second dataset, and a third dataset from the input data, wherein the first dataset provides a rejection history for the plurality of potential plans, wherein the second dataset indicates receptiveness level of the user, wherein the third dataset includes confidence levels of expected reward values for each of the plurality of potential plans; determine an exploration score based on the first dataset, the second dataset, the third dataset, and the input data; determine a strategy based on the determined exploration score; and cause the digital assistant to perform at least one of the plurality of potential plans based on the determined strategy.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various embodiments of the disclosure.

FIG. 2 is a block diagram of a controller according to an embodiment.

FIG. 3 is a flowchart illustrating a method for conducting exploration and exploitation strategy of digital assistant according to an embodiment.

FIG. 4 is a flowchart illustrating a method for improving conducting of exploration and exploitation strategy of a digital assistant according to an embodiment.

### DETAILED DESCRIPTION

The embodiments disclosed by the disclosure are only examples of the many possible advantageous uses and implementations of the innovative teachings presented herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality. In the drawings, like numerals refer to like parts through several views.

The various disclosed embodiments provide techniques for effectively determining exploration and exploitation strategies for users of the digital assistant by incorporating external input data related to the actual users and their current state. A plurality of potential plans that include an optimal plan (exploitation strategy) and at least a suboptimal plan (exploration strategy) is identified based on input data of the user and thus, specific for the user and their current state. Input data, including the user's historical data and real-time data of the user and their environment, may be used to extract additional datasets; and together, may be further utilized to determine an exploration score of the digital assistant. The exploration score, in an embodiment, provides a numerical decision value to objectively determine whether to explore or exploit. It should be appreciated that selecting and presenting an appropriate potential plan is essential in collecting accurate user responses, which in return enables accurate and effective learning of the digital assistant to serve the respective user. Moreover, identifying applicable potential plans can reduce processing traffic and speed by eliminating the need to process unrelated plans designed to be executed by the digital assistant.

It has been identified that the exploration-exploitation trade-off, to decide between exploring new plans against maximizing reward by exploiting, is an ongoing dilemma for digital assistants adapting reinforcement learning techniques. To this end, the disclosed embodiments, provide method and system to improve the decision making of such dilemma in reinforcement learning to more accurately and effectively select between the two strategies (i.e., exploration strategy and exploitation strategy). Rather than making random selections and selections based on device state that may sacrifice chances of rewards, the disclosed embodiments incorporate external data from actual users of the digital assistant from which the feedback regarding the respective plan will be received from. In this regard, the disclosed embodiments herein provide specific improvements in reinforcement learning technology by determining numerical exploration scores for determining exploration and exploitation strategies and presenting suitable potential plans, all based on input data, for example real-time and historical data, of the specific user of the digital assistant.

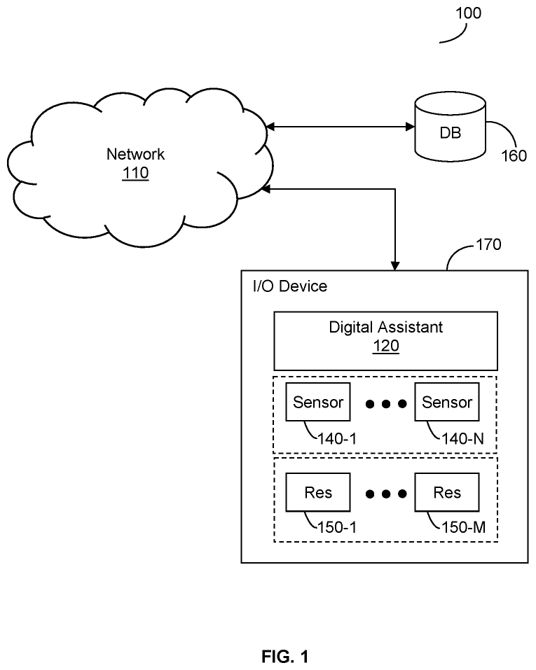

FIG. 1 is an example network diagram 100 utilized to describe the various disclosed embodiments. The network diagram 100 includes an input/output (I/O) device 170 operating a digital assistant 120. In some embodiments, the digital assistant 120 is further connected to a network 110 to allow some processing of a remote server (e.g., a cloud server). The network 110 may provide for communication between the elements shown in the network diagram 100. The network 110 may be, but is not limited to, a local area network (LAN), a wide area network (WAN), a metro area network (MAN), the Internet, a wireless, cellular, or wired network, and the like, and any combination thereof.

In an embodiment, the digital assistant 120 may be connected to, or implemented on, the I/O device 170. The I/O device 170 may be, for example and without limitation, a robot, a social robot, a service robot, a smart TV, a smartphone, a wearable device, a vehicle, a computer, a smart appliance, and the like.

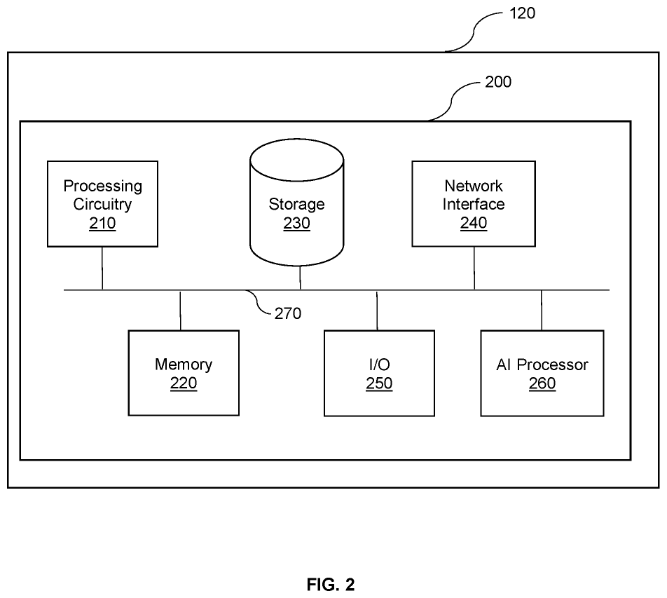

The digital assistant 120 may be realized in software, firmware, hardware, and any combination thereof. An example block diagram of a controller that may execute the processes of the digital assistant 120 is provided in FIG. 2. The digital assistant 120 is configured to process sensor data collected by one or more sensors, 140-1 to 140-N, where N is an integer equal to or greater than 1 (hereinafter referred to as “sensor” 140 or “sensors” 140 for simplicity) and one or more resources 150-1 to 150-M, where M is an integer equal to or greater than 1 (hereinafter referred to as “resource” 150 or “resources” 150 for simplicity). The resources 150 may include, for example, electro-mechanical elements, display units, speakers, and the like. In an embodiment, the resources 150 may include sensors 140 as well. The sensors 140 and the resources 150 are included in the I/O device 170.

The sensors 140 may include input devices, such as various sensors, detectors, microphones, touch sensors, movement detectors, cameras, and the like. Any of the sensors 140 may be, but are not necessarily, communicatively, or otherwise connected to the digital assistant 120 (such connection is not illustrated in FIG. 1 for the sake of simplicity and without limitation on the disclosed embodiments). The sensors 140 may be configured to sense signals received from a user interacting with the I/O device 170 or the digital assistant 120, signals received from the environment surrounding the user, and the like. In an embodiment, the sensors 140 may be implemented as virtual sensors that receive inputs from online services, for example, the weather forecast, a user's calendar, and the like.

In an embodiment, a database (DB) 160 may be utilized. The database 160 may be part of the I/O device 170 (e.g., within a storage device not shown), or may be separate from the I/O device 170 and connected thereto via the network 110. The database 160 may be utilized for storing, for example, data regarding one or more users, historical data, plans designed to be executed by the digital assistant 120, and the like, as further discussed herein below with respect to FIG. 2.

FIG. 2 is an example block diagram of a controller 200 acting as a hardware layer of a digital assistant 120, according to an embodiment. The controller 200 includes a processing circuitry 210 that is configured to receive data, analyze data, generate outputs, and the like, as further described hereinbelow. The processing circuitry 210 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The controller 200 further includes a memory 220. The memory 220 may contain therein instructions that, when executed by the processing circuitry 210, can cause the controller 200 to execute actions as further described hereinbelow. The memory 220 may further store therein information, for example, data associated with one or more users, historical data, plans designed to be executed by the digital assistant, and the like.

The storage 230 may be magnetic storage, optical storage, and the like, and may be realized, for example, as a flash memory or other memory technology, or any other medium which can be used to store the desired information.

In an embodiment, the controller 200 includes a network interface 240 that is configured to connect to a network, e.g., the network 110 of FIG. 1. The network interface 240 may include, but is not limited to, a wired interface (e.g., an Ethernet port) or a wireless port (e.g., an 802.11 compliant Wi-Fi card), configured to connect to a network (not shown).

The controller 200 further includes an input/output (I/O) interface 250 configured to control the resources (150, FIG. 1) which are connected to the digital assistant 120. In an embodiment, the I/O interface 250 is configured to receive one or more signals captured by the sensors (140, FIG. 1) of the digital assistant (120, FIG. 1) and to send such signals to the processing circuitry 210 for analysis. In an embodiment, the I/O interface 250 is configured to analyze the signals captured by the sensors 140, detectors, and the like. In a further embodiment, the I/O interface 250 is configured to send one or more commands to one or more of the resources 150 for executing one or more plans of the digital assistant 120, as further discussed herein below. A plan may include, for example, presenting and/or suggesting an action according to a user's input data and further analyses. In further embodiment, the components of the controller 200 are connected via a bus 270.

In some configurations, the controller 200 may further include an artificial intelligence (AI) processor 260. The AI processor 260 may be realized as one or more hardware logic components and circuits, including graphics processing units (GPUs), tensor processing units (TPUs), neural processing units, vision processing units (VPU), reconfigurable field-programmable gate arrays (FPGA), and the like. The AI processor 260 is configured to perform, for example, machine learning based on sensory inputs received from the I/O interface 250, where the I/O interface 250 receives input data, such as sensory inputs, from the sensors 140.

In an embodiment, the controller 200 is configured to collect a set of input data about at least the user of a digital assistant 120 (e.g., the digital assistant 120). It should be noted that the digital assistant realized by the controller 200 may be associated with multiple users and collect input data for each of the multiple users. The set of input data may include real-time data as well as historical data about the user and the user's environment. The real-time data may be sensed and collected using one or more sensors (e.g., the sensors 140, FIG. 1), and may indicate, for example, the user's mood, the specific location of the user, whether the user is awake or asleep, whether the user is watching television, listening to music, and the like. In a further embodiment, the controller 200 may be configured to collect real-time data about the user's environment, such as the current number of people near the user, the time, the current weather, and so on. The historical data may refer to wide range of aspects related to the user, such as the user's preferences, experience level in certain types of sports, user's health record, and so on. As an example, the historical data may indicate that the user likes to listen to Jazz music, likes to do long walks, that the user is a yoga instructor, and the like.

In an embodiment, the controller 200, when executing the digital assistant 120, is configured to analyze the set of input data by applying at least one algorithm, such as a machine learning algorithm, that may be stored in a memory (e.g., the memory 220). The algorithm may facilitate determination of at least a current state of at least the user based on at least a portion of the collected set of input data. In a further embodiment, the algorithm may facilitate determination of a current state of the environment near the user (e.g., in a predetermined proximity to the user) based on at least a portion of the collected set of input data.

The current state may reflect the condition of the user and the condition of the environment near the user in real-time, or near real-time. The current state may indicate whether, for example, the user is sleeping, reading, stressed, angry, and so on. The current state may further indicate the current time, weather, number of people in the room, people identity, and so on. As an example, the determined current state may indicate that the time is 6 pm, that the user has been watching TV for more than two hours, and that the user seems to be very bored. It should be noted that the collected set of input data may be fed into the abovementioned algorithm, therefore allowing the algorithm to determine the current state. According to further embodiment, the collected set of input data may be analyzed using, for example and without limitations, one or more computer vision techniques, audio signal processing techniques, machine learning techniques, and the like.

In an embodiment, the controller 200 is configured to generate an expected reward value for each plan designed to be executed by the digital assistant 120. A reward is a numerical value received by the digital assistant 120 that is generated by, for example, the user as a direct response to a plan that has been executed by the digital assistant 120. The goal of the digital assistant 120 is to maximize the overall expected reward the digital assistant 120 receives. Every executed plan yields rewards, which can be roughly divided to two types: a positive reward which is indicative to a desired action, and a negative reward which is indicative to an action the digital assistant 120 should avoid. The expected reward value refers to, for example, the probability of each plan to be accepted by the user, the sentiment of the user with respect each plan, and the like. The expected reward value may be generated for each plan of the plurality of potential plans based on the determined current state and the historical data of the user. In an embodiment, the determined current state and the historical data of the user are analyzed in order to determine and generate the expected reward value for each plan of the plurality of plans. Such an analysis may be achieved using, for example, one or more designated machine learning algorithms. According to a further embodiment, the controller 200 may be configured to determine and generate expected reward values only for relevant potential plans based on the current state. That is, in some scenarios (i.e., states) it may not be appropriate to suggest certain plans and therefore by not calculating the expected reward values for these irrelevant plans, processing time as well as processing costs may be reduced.

In an embodiment, the controller 200, when executing the digital assistant 120, is configured to identify a plurality of potential plans that are relevant to the current state based on collected set of input data from the user. More particularly, in an embodiment, the determined current state and the historical data of the user may be utilized. The plurality of potential plans may include an optimal plan and at least a suboptimal plan. Optimal plan is a plan having the highest expected reward value. The optimal plan may be a plan that has been suggested to the user in several scenarios and was accepted by the user in each time. That is, the user is familiar with the optimal plan and has a positive record in, for example, accepting the plan when the plan has been previously suggested to the user. On the other hand, suboptimal plans are plans that each has an expected reward value that is below the highest expected reward value. Suboptimal plans may include (a) new plans that were not offered to the user in the past, (b) plans that were not offered to the user in a specific current state and, (c) plans that were previously offered to the user but rejected by the user. As an example, the plurality of potential plans may include for example, a plan suggesting the user to listen to music, a plan suggesting the user to go out for a walk, a plan suggesting the user to watch a movie, a plan suggesting the user to try practicing yoga for the first time, and so on.

As an example, the controller 200, when executing the digital assistant 120, is configured to determine that the user has been sitting on the couch doing nothing for two hours. According to the same example, there may be four potential plans, the first plan refers to suggesting the user to go out for a walk, the second plan refers to suggesting the user to watch TV, the third plan refers to suggesting the user to try practicing yoga for the first time, and the fourth plan refers to suggesting the user to play a cognitive game. The optimal plan, having the highest expected reward value in this specific state (e.g., the highest probability to be accepted by the user in this specific state), may be the second plan as the user had accepted 35 suggestions to watch TV in the past, and never rejected this plan nor showed any negative response to a suggestion to watch TV.

According to the same example, the other potential plans are suboptimal plans, each having an expected reward value less than the highest expected reward value. It should be noted that the other potential plans may be classified as suboptimal for different reasons. For example, the first plan may be offered to the user before but not in a scenario (state) that is similar to the current scenario (current state), the third plan may be a new plan that was never offered to the user before, and the fourth plan may be previously offered but rejected by the user. Therefore, these three potential plans may be classified as suboptimal plans. It should be noted that the expected reward value may be, for example, any number between “0” to “1”, where “0” is the lowest value and “1” is the highest. An expected reward value of “0” indicates that, for example, the user will react in a very negative manner in response to the suggested plan, will probability reject the suggested plan, and the like. An expected reward value of “1” (i.e., the highest value) indicates that the user will react in a very positive manner in response to the suggested plan, that the probability that the user will accept the suggested plan is the highest, and the like. It should be further noted that the optimal plan is associated with the highest expected reward value, which means that the optimal plan has the highest probability to be accepted by the user.

According to another embodiment, the controller 200 may be configured to extract, a first dataset regarding plans' rejection history for the user, a second dataset regarding current receptiveness level of the user, and a third dataset regarding a confidence level with respect to the generated expected reward value of each potential plan of the plurality of potential plans from the collected set of input data. In yet another embodiment, the controller 200 may be configured to collect the first dataset, the second dataset, and the third dataset.

The first dataset is indicative to recorded historical events related to suggestions that have been rejected by the user of the digital assistant 120. For example, a historical event may include a plan for a daily short walk and the user rejected the suggested plan. The first dataset may be collected from, for example, a database (e.g., the database 160).

The second dataset is indicative to the current receptiveness level of the user. The receptiveness level refers to a certain (e.g., emotional) state of the user that allows the user to be susceptible to suggestions. For example, when the user is angry, nervous, etc., the receptiveness level may be relatively low, however, when the user seems to be calm, smiling, laughing, etc., the receptiveness level may be relatively high. The second dataset regarding the current receptiveness level may be extracted from the abovementioned real-time data. As noted above, the real-time data may be collected using one or more sensors (e.g., the sensors 140). Also, the current state of at least the user that is determined based on analysis of at least the real-time data, may be indicative to the current receptiveness level of the user.

The third dataset is indicative to a confidence level with respect to the generated expected reward value of each potential plan of the plurality of potential plans. The confidence level may be implemented as a number from “0” to “5” where “0” indicates the lowest confidence level and “5” indicates the highest confidence level. For example, the confidence level in an expected reward value of a plan that suggests watching TV may be relatively high as the plan to watch TV has been suggested many times and the user accepted the plan each time in many different states. As another example, the confidence level in an expected reward value of a plan that suggests starting practicing yoga for the first time may be relatively low as this plan was never suggested to the user.

In an embodiment, the controller 200, when executing the digital assistant 120, is configured to apply at least one algorithm, such as a machine learning algorithm, to the first dataset, the second dataset, the third dataset, and the collected set of input data. The at least one algorithm is adapted to determine an exploration score. The exploration score with a comparison to a predetermined threshold value is utilized to determine whether to execute the optimal plan or the at least one suboptimal plan.

That is, the first dataset, the second dataset, the third dataset, and the collected set of input data may be fed into the at least one algorithm to determine an exploration score, therefore allowing to determine whether to use exploration strategy to execute a suboptimal plan to the user or use exploitation strategy to execute an optimal plan to the user. In an embodiment, the algorithm is further adapted to select a specific suboptimal plan to be executed when needed. According to another embodiment, a fourth optional dataset including the user's personality properties, may be collected and analyzed, together with the abovementioned datasets, to determine an exploration score. The user's personality properties may indicate for example, whether the user is a cynical person, having a good sense of humor or not, whether the user is a sensitive person or not, and so on.

As an example, the collected set of input data indicates that (a) the user is alone in the house, (b) the user seems to be calm while (c) watching TV for two hours, and (d) it is rainy outside. According to the same example, the first dataset indicates that the user has previously rejected nine out of ten potential plans (except playing a cognitive game) that may suit the current state, the second dataset indicates that the receptiveness level of the user is relatively high (alone, calm, not doing anything important), and the third dataset indicates that the confidence level of the generated expected reward value of each of the ten potential plans is relatively high.

Thus, based on the inputs received and input into the algorithm, the algorithm may determine an exploration score that is equal or greater than a predetermined threshold score and thus, select the exploration strategy. In this case, the controller 200 is configured to execute one of the nine suboptimal plans (i.e., exploration strategy) and not the optimal plan of playing a cognitive game (i.e., exploitation strategy), even though all parameters (e.g., the high expected reward value) indicated that the user would accept a suggestion to play a cognitive game. According to the same example, the two suboptimal plans having the relatively higher expected reward values (among the nine suboptimal plans) are: suggest doing meditation (plan A) and suggest listening to Jazz music (plan B). The algorithm may select plan A over plan B based on, for example, information such as: the user has previously rejected plan B on eight occasions out of 30 occasions at which plan B has been suggested to the user; plan A was never rejected by the user at this specific state, and so on.

According to one embodiment, upon determining to execute the exploration strategy and the at least one suboptimal plan, the controller 200 is configured to select and execute a specific suboptimal plan. Upon determining to execute the exploitation strategy based on an exploration score that is less than a predetermined threshold score, the optimal plan is executed. Executing and presenting the optimal or the suboptimal plan may be performed using one or more resources (e.g., the resources 150) that are included in the I/O device and controlled by the digital assistant 120. In an embodiment, resources to present the optimal plan or the suboptimal plan may be for example, a speaker, a display unit, a smartphone, and the like, that is communicatively connected to the digital assistant 120.

It should be noted that each plan may be executed and presented to the user using different manners, flows, and expressions. As an example, a plan, such as suggesting the user to start doing physical activity may be executed using a cynical approach having a specific flow that is customized to the user, and using only the speaker of the I/O device incorporating with the digital assistant 120. In an embodiment, the way (manner, specific flow, and expressions) by which a plan is generated may be determined upon applying the at least one algorithm to the first dataset, the second dataset, the third dataset, and the collected set of input data.

In an example, after a potential plan is selected by the digital assistant 120 (e.g., to suggest the user to practice yoga for the first time), the controller 200 may be configured to manage other decisions that need to be determined when executing the selected plan using the disclosed method. That is, for each decision, such as but not limited to, decide which approach to use when communicating (or presenting) the selected plan to the user, which form of expression should be used, and the like, a selection as to whether to explore or exploit is determined. In an example embodiment, the controller 200 may be configured to determine an approach to communicate with a user (e.g., tones such cynical, lovable, and the like; specific resource to use) using the disclosed method herein. It should be noted that the method of determining whether to exploit or explore using the abovementioned inputs, may be used whenever a decision should be taken, i.e., not only when planning the execution of a potential plan (or action).

According to another embodiment, the controller 200 may be configured to generate at least a question to be presented to the user. The question may refer to whether the user would like the digital assistant 120 to execute the at least a suboptimal plan. That is, a question asking the user whether she or he wishes to perform an action (e.g., practice yoga) suggested by a plan (e.g., a suggestion to practice yoga) that is currently classified as a suboptimal plan. As an example, upon determining to explore and to suggest the user to try practicing yoga for the first time (i.e., a suboptimal plan), the controller 200 may generate a question such as: “you usually enjoy doing physical activity, how about we try yoga for the first time?”. The question may be presented to the user by the controller 200 using one or more resources (e.g., the resources 150), such as a speaker, a display unit, and the like. The user response (or feedback) to the question may be collected using one or more sensors (e.g., the sensors 140).

It should be noted that the user response may indicate that the user accepts the new plan or rejects the new plan. In an embodiment, sensory data indicating the user response may be collected and stored within a database. The collected sensory data with respect to the user response may be used as an input to the abovementioned algorithm in order to improve future decisions of the digital assistant 120 (e.g., whether to explore or exploit in different scenarios).

It should be noted that based on the user response, the controller 200 may be configured to execute the suboptimal plan, execute the optimal plan, adjust the presentation of the selected plan, and so on. In an embodiment, the controller 200 may be configured to adjust the presentation of the determined plan based on the user response. The adjusted plan may be presented to the user using one or more resources (e.g., the resources 150). For example, when a suboptimal (or optimal) plan that suggests the user to go out for a walk is rejected by the user (e.g., by analyzing the user response), the controller 200 may adjust the plan to include a suggestion to invite the user's best friend to join the walk.

That is, as opposed to known solutions by which the determination whether to explore new areas or exploit known knowledge is achieved based on traditional methods such as Epsilon-Greedy (which is a method used to balance exploration and exploitation by choosing between exploration and exploitation randomly), the disclosed system and method also consider various collected inputs, such as, data regarding failed attempts to suggest new plans, receptiveness level of the user, and more, in order to reduce the probability that the user will reject the suggested plan, gets frustrated, and possibly abandon the digital assistant.

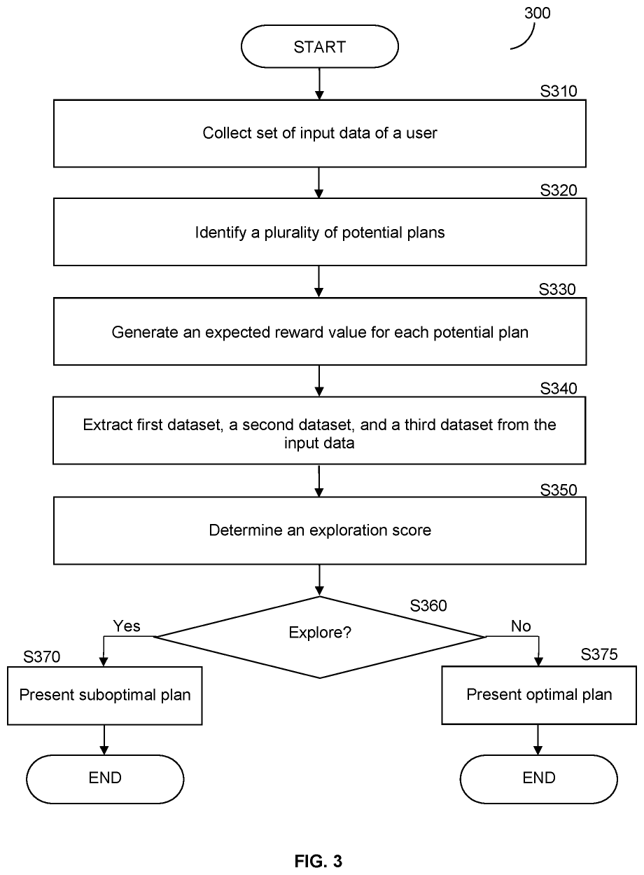

FIG. 3 shows an example flowchart 300 of a method for conducting exploration and exploitation strategy of a digital assistant, according to an embodiment. The method described herein may be executed by the controller 200 that is further described herein above with respect to FIG. 2. As noted above, the controller 200 is a hardware layer running the digital assistant 120.

At S310, a set of input data of a user is collected. The set of input data may include real-time data as well as historical data about the user and the user's environment. In an embodiment, the real-time data about the user and the user environment in a predetermined proximity to the user is collected by the digital assistant (or controller 200). The real-time data of the user and the user environment may be sensed or otherwise collected using one or more sensors (e.g., the sensors 140, FIG. 1). In an embodiment, at least one algorithm, such as a machine learning algorithm, may be applied to real-time data of the user and the user environment and adapted determine a current state of the user of the digital assistant. The current state may indicate whether, for example, the user is sleeping, reading, stressed, angry, and so on. The current state may further indicate the current time, weather, number of people in the room, people identity, and more.

At S320, a plurality of potential plans is identified. The potential plans are identified from the plans that are designed to be executed at the digital assistant based on the collected set of input data of the user. In an embodiment, the plurality of potential plans includes an optimal plan and at least one suboptimal plan that are suitable for the user at their current state. The optimal plan and suboptimal plans may be identified according to the expected reward values.

At S330, an expected reward value is generated for each potential plan of a plurality of potential plans. As noted above, the expected reward value refers to, for example, the probability of each potential plan to be accepted by the user, the sentiment of the user with respect each potential plan, and the like. Each of the plurality of potential plans is designed to be executed by the digital assistant 120. In an embodiment, the expected reward value may be generated based on the determined current state and the historical data of the user. The plurality of potential plans may include an optimal plan and at least a suboptimal plan. According to the generated expected reward values, the optimal plan has the highest expected reward value and the suboptimal plans each has an expected reward value that is below the highest expected reward value, as further discussed with respect to FIG. 2.

At S340, a first dataset, a second dataset, and a third dataset are extracted from the collected set of input data. The first dataset includes potential plans' rejection history of the user, the second dataset indicates current receptiveness level of the user, and the third dataset includes a confidence level with respect to the generated expected reward value for each potential plan of the identified plurality of the potential plans. Each dataset is further described in greater detail with respect to FIG. 2.

At S350, an exploration score is determined. The exploration score may be determined by applying at least a designated algorithm, such as a machine learning algorithm, based on the first dataset, the second dataset, the third dataset, and the collected input data of the user. In an optional embodiment, a fourth optional dataset including the user's personality properties may also be applied to the designated algorithm, in addition to the abovementioned datasets, to determine an exploration score. In an embodiment, the exploration score may be utilized to determine whether to present optimal plan to the user (i.e., exploit) or suggest one of the suboptimal plans (i.e., explore). In further embodiment, at least a designated algorithm may be adapted to determine a specific suboptimal plan to execute for the exploration strategy.

At S360, it is checked whether to execute an exploration strategy. If so, execution continues with S370, otherwise, execution continues with S375. In an embodiment, the exploration strategy (S370) is selected when the determined exploration score is equal or greater than a predetermined threshold score. In another embodiment, an exploitation strategy (S375) is selected when the determined exploration score is less than a predetermined threshold score. In an embodiment, the predetermined threshold score may be predefined and stored in a memory (e.g., 220, FIG. 2).

At S370, one of the at least one suboptimal plan is executed (i.e., exploration strategy). The suboptimal plan may be presented using one or more resources (e.g., the resources 150) that are communicatively connected to and controlled by the digital assistant (e.g., the digital assistant 120). In an embodiment, a specific suboptimal plan to execute is determined by applying a designated algorithm, as performed in S350.

At S375, the optimal plan of the plurality of the potential plans is executed (i.e., exploitation strategy). The optimal plan may be presented using one or more resources (e.g., the resources 150) that are communicatively connected to and controlled by the digital assistant (e.g., the digital assistant 120). It should be noted that an optimal plan may cause the digital assistant 120 to not present anything and not interrupt the user.

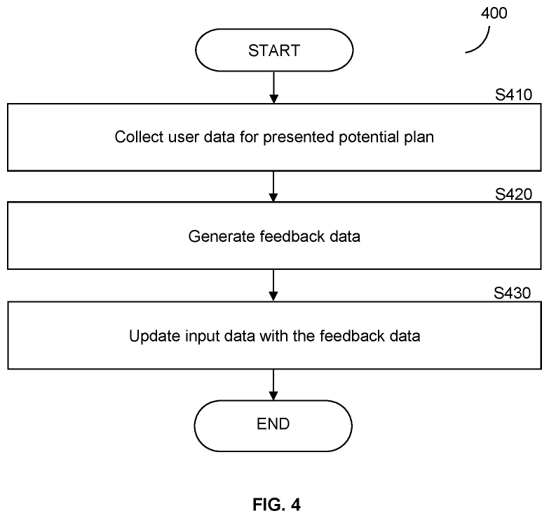

FIG. 4 shows an example flowchart 400 of a method for improving the execution of exploration and exploitation strategy of a digital assistant according to an embodiment. The method described herein may be executed by the controller 200 that is further described herein above with respect to FIG. 2.

At S410, user data for the presented potential plan is collected. The potential plan may be an optimal or a suboptimal plan. In an embodiment, the collected user data may include user reply, user reaction, user sensory data, and the like, to indicate user response to the respective potential plan. The user data may be collected using one or more sensors (e.g., the sensors 140) of the digital assistant 120.

At S420, the collected user data is analyzed in order to determine a feedback data indicating user response. The analysis may be achieved using, for example, one or more computer vision techniques, audio signal processing techniques, machine learning techniques, and the like. In an embodiment, the analyzed feedback data may be stored for future usage in a database (e.g., the database 160).

At S430, the input data is updated based on the analyzed feedback data with respect to the presented plan. The update of the input data enables improvement and optimization of the method illustrated in FIG. 3. Moreover, more accurate selection and presentation of specific suboptimal plan may be allowed. In an example embodiment, the expected reward value of a specific plan may be modified according to the feedback data. In another example embodiment, the manner, flow, and expressions in which are used to execute and present the potential plan may be modified accordingly.

In a non-limiting example, one specific suboptimal plan has been rejected by the user in the past when the user had company at home. However, when the plan was executed in a different state, when the user was alone at home, the user reaction was very positive and accepted the suggested suboptimal plan. Thus, user data regarding the user response is collected and analyzed (using, for example, one or more machine learning algorithm) in order to improve future decisions and reinforcement learning of the digital assistant 120 (e.g., adjust the expected reward value of the specific plan). Similarly, in another non-limiting example, the user reaction to a plan that was considered to be an optimal plan in a certain state, was very negative for the first time. Such user data can be collected and analyzed to provide feedback data to the digital assistant in order to improve future decisions of the digital assistant 120, such as to prevent the specific plan from being classified as an optimal plan again.

The various disclosed embodiments can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for conducting a strategy of a digital assistant, comprising:
identifying a plurality of potential plans for a user based on input data, wherein the plurality of potential plans includes an optimal plan having a highest expected reward value and at least one suboptimal plan having an expected reward value less than the highest expected reward value, wherein the input data includes historical data and a current state of the user;
extracting a first dataset, a second dataset, and a third dataset from the input data, wherein the first dataset provides a rejection history for the plurality of potential plans, wherein the second dataset indicates a receptiveness level of the user, wherein the third dataset includes confidence levels of expected reward values for each of the plurality of potential plans;
determining an exploration score based on the first dataset, the second dataset, the third dataset, and the input data;
determining a strategy based on the determined exploration score; and
causing the digital assistant to perform at least one of the plurality of potential plans based on the determined strategy.

2. The method of claim 1, wherein the strategy is an exploitation strategy when the exploration score is less than a predetermined threshold score, and wherein the exploitation strategy causes the digital assistant to perform the optimal plan.

3. The method of claim 1, wherein the strategy is an exploration strategy when the exploration score is equal or greater than a predetermined threshold score, and wherein the exploration strategy causes the digital assistant to perform the at least one suboptimal plan.

4. The method of claim 3, further comprising:
determining a specific suboptimal plan for the at least one suboptimal plan based on the first dataset, the second dataset, a third dataset, and the input data; and
causing the digital assistant to perform the determined specific suboptimal plan.

5. The method of claim 1, further comprising:
applying a machine learning model trained to determine the current state based on real-time data of the user and real-time data of an environment in a predetermined proximity to the user in real time.

6. The method of claim 5, wherein the real-time data of the user and a real-time data of an environment is captured by at least one sensor of an I/O device.

7. The method of claim 1, wherein the at least one of the plurality of potential plans are presented by at least one resource of an I/O device.

8. The method of claim 1, further comprising:
generating the expected reward values for each of the plurality of potential plans based on the current state and the historical data of the user, wherein the expected reward value is a numerical value to indicate probability of user to accept the respective performed potential plan.

9. The method of claim 1, further comprising:
generating feedback data, based on user data for the performed potential plan, wherein the user data includes at least one of: a user reply, a user reaction, and a sensory data of user;
storing the feedback data of the user for the performed potential plan; and
updating the input data.

10. A non-transitory computer readable medium having stored thereon instructions for causing a processing circuitry to execute a process, the process comprising:
identifying a plurality of potential plans for a user based on input data, wherein the plurality of potential plans includes an optimal plan having a highest expected reward value and at least one suboptimal plan having an expected reward value less than the highest expected reward value, wherein the input data includes historical data and a current state of the user;
extracting a first dataset, a second dataset, and a third dataset from the input data, wherein the first dataset provides a rejection history for the plurality of potential plans, wherein the second dataset indicates a receptiveness level of the user, wherein the third dataset includes confidence levels of expected reward values for each of the plurality of potential plans;
determining an exploration score based on the first dataset, the second dataset, the third dataset, and the input data;
determining a strategy based on the determined exploration score; and
causing the digital assistant to perform at least one of the plurality of potential plans based on the determined strategy.

11. A system for conducting a strategy of a digital assistant, comprising:
a processing circuitry; and
a memory, the memory containing instructions that, when executed by the processing circuitry, configure the system to:
identify a plurality of potential plans for a user based on input data, wherein the plurality of potential plans includes an optimal plan having a highest expected reward value and at least one suboptimal plan having an expected reward value less than the highest expected reward value, wherein the input data includes historical data and a current state of the user;
extract a first dataset, a second dataset, and a third dataset from the input data, wherein the first dataset provides a rejection history for the plurality of potential plans, wherein the second dataset indicates a receptiveness level of the user, wherein the third dataset includes confidence levels of expected reward values for each of the plurality of potential plans;
determine an exploration score based on the first dataset, the second dataset, the third dataset, and the input data;
determine a strategy based on the determined exploration score; and
cause the digital assistant to perform at least one of the plurality of potential plans based on the determined strategy.

12. The system of claim 11, wherein the strategy is an exploitation strategy when the exploration score is less than a predetermined threshold score, and wherein the exploitation strategy causes the digital assistant to perform the optimal plan.

13. The system of claim 11, wherein the strategy is an exploration strategy when the exploration score is equal or greater than a predetermined threshold score, and wherein the exploration strategy causes the digital assistant to perform the at least one suboptimal plan.

14. The system of claim 13, wherein the system is further configured to:
determine a specific suboptimal plan for the at least one suboptimal plan based on the first dataset, the second dataset, a third dataset, and the input data; and
cause the digital assistant to perform the determined specific suboptimal plan.

15. The system of claim 11, wherein the system is further configured to:
apply a machine learning model trained to determine the current state based on real-time data of the user and real-time data of an environment in a predetermined proximity to the user in real time.

16. The system of claim 11, wherein the real-time data of the user and a real-time data of an environment is captured by at least one sensor of an I/O device.

17. The system of claim 11, wherein the at least one of the plurality of potential plans are presented by at least one resource of an I/O device.

18. The system of claim 15, wherein the system is further configured to:
generate the expected reward values for each of the plurality of potential plans based on the current state and the historical data of the user, wherein the expected reward value is a numerical value to indicate probability of user to accept the respective performed potential plan.

19. The system of claim 11, wherein the system is further configured to:
generate feedback data, based on user data for the performed potential plan, wherein the user data includes at least one of: a user reply, a user reaction, and a sensory data of user;
store the feedback data of the user for the performed potential plan; and
update the input data.
